(19) United States
(12) Patent Application Publication
(10) Pub. No.: US 2026/0185840 A1
(43) Pub. Date: Jul. 2, 2026

(54) APPARATUS AND METHOD FOR WALKING ROUTE GUIDANCE BASED ON VISION-LANGUAGE MODEL

(71) Applicant: ELECTRONICS AND TELECOMMUNICATIONS RESEARCH INSTITUTE, Daejeon (KR)

(72) Inventors: Woo-Han YUN, Daejeon (KR); Byung-Ok HAN, Daejeon (KR)

(21) Appl. No.: 19/373,965

(22) Filed: Oct. 30, 2025

(30) Foreign Application Priority Data
Dec. 30, 2024 (KR) 10-2024-0200315

(51) Int. Cl. G01C 21/34; G06F 40/40; G06V 10/25; G06V 20/50

(52) U.S. Cl. CPC G01C 21/3461; G06F 40/40; G06V 10/25; G06V 20/50

(57) ABSTRACT

Disclosed herein is an apparatus and method for walking route guidance based on a vision-language model. The method may include setting a walking route to a destination position in a pedestrian-perspective image, generating a query sentence by reflecting current condition information of a pedestrian to a query input by the pedestrian, obtaining an answer of a vision-language model by inputting the generated query sentence and the pedestrian-perspective image, and providing walking guidance based on the answer of the vision-language model.

### CROSS REFERENCE TO RELATED APPLICATION

This application claims the benefit of Korean Patent Application No. 10-2024-0200315, filed Dec. 30, 2024, which is hereby incorporated by reference in its entirety into this application.

### BACKGROUND OF THE INVENTION

### 1. Technical Field

The disclosed embodiment relates to technology for providing guidance on a route to a specific point in an image.

### 2. Description of Related Art

The need for a system that provides real-time route guidance and surrounding environment information for users who are visually impaired or require walking assistance has existed for a long time.

Existing route guidance systems primarily utilize GPS-based location information and predefined map data to provide routes. However, these systems have limitations in detecting changes in the surrounding environment or obstacles in real time and delivering the same to users.

Furthermore, these systems do not consider the user's walking speed or individual characteristics, which may degrade the user experience and cause safety concerns.

### SUMMARY OF THE INVENTION

An object of the disclosed embodiment is to detect changes in the pedestrian's surrounding environment and obstacles in real time and deliver the same to the user.

Another object of the disclosed embodiment is to improve user experience by taking into account the user's walking speed and individual characteristics, while also addressing safety issues.

A method for walking route guidance based on a vision-language model according to an embodiment may include setting a walking route to a destination position in a pedestrian-perspective image, generating a query sentence by reflecting current condition information of a pedestrian to a query input by the pedestrian, obtaining an answer of a vision-language model by inputting the generated query sentence and the pedestrian-perspective image, and providing walking guidance based on the answer of the vision-language model.

Here, setting the walking route may comprise searching for an optimal route for minimizing a movement route from the current position of the pedestrian to the destination position, and at least one of an algorithm for minimizing depth variation of the movement route based on a depth map, or a walkable area segmentation algorithm, or a combination thereof may be used.

Here, setting the walking route may comprise computing left and right points at a predetermined distance from each of a predetermined number of points on the walking route.

The method for walking route guidance based on a vision-language model according to an embodiment may further include generating a mask image by extracting only a predetermined region of interest from the pedestrian-perspective image, and obtaining the answer of the vision-language model may comprise inputting a mask image corresponding to the generated query sentence to the vision-language model.

Here, generating the mask image may comprise generating at least one of a destination region mask from the pedestrian-perspective image, a path region mask that connects left-side and right-side points of the walking route in the pedestrian-perspective image, a left-of-path region mask that connects upper-left and lower-left points of the pedestrian-perspective image and the left-side points of the walking route, or a right-of-path region mask that connects upper-right and lower-right points of the pedestrian-perspective image and the right-side points of the walking route, or a combination thereof and generating the mask image by intersecting the generated at least one region-specific mask with the pedestrian-perspective image.

Here, the method for walking route guidance based on a vision-language model according to an embodiment may further include estimating the speed of the pedestrian, and generating the mask image may comprise additionally generating a far-distance mask that reflects the speed of the pedestrian and generating at least one mask image by intersecting the generated at least one region-specific mask, the far-distance mask, and the pedestrian-perspective image.

Here, obtaining the answer of the vision-language model may include inputting the query sentence and at least one region-specific mask image corresponding thereto to the vision-language model and generating a descriptive sentence for describing the pedestrian-perspective image by combining at least one answer obtained from the vision-language model.

Here, obtaining the answer of the vision-language model may further include adding a query sentence about walkability to the descriptive sentence for describing the pedestrian-perspective image, inputting the descriptive sentence to the vision-language model, and obtaining an answer indicating walkability along the walking route from the vision-language model.

Here, providing the walking guidance may comprise removing keywords other than walking-related and risk-related keywords from at least one answer obtained from the vision-language model and constructing a single sentence from remaining portion of the answer.

An apparatus for walking route guidance based on a vision-language model according to an embodiment includes memory in which at least one program is recorded and a processor for executing the program, and the program may set a walking route to a destination position in a pedestrian-perspective image, generate a query sentence by reflecting current condition information of a pedestrian to a query input by the pedestrian, obtain an answer of a vision-language model by inputting the generated query sentence and the pedestrian-perspective image, and provide walking guidance based on the answer of the vision-language model.

Here, when setting the walking route, the program may search for an optimal route for minimizing a movement route from the current position of the pedestrian to the destination position and use at least one of an algorithm for minimizing depth variation of the movement route based on a depth map, or a walkable area segmentation algorithm, or a combination thereof.

Here, when setting the walking route, the program may compute left and right points at a predetermined distance from each of a predetermined number of points on the walking route.

Here, the program may generate a mask image by extracting only a predetermined region of interest from the pedestrian-perspective image, and when obtaining the answer of the vision-language model, the program may input a mask image corresponding to the generated query sentence to the vision-language model.

Here, when generating the mask image, the program may generate at least one of a destination region mask from the pedestrian-perspective image, a path region mask that connects left-side and right-side points of the walking route in the pedestrian-perspective image, a left-of-path region mask that connects upper-left and lower-left points of the pedestrian-perspective image and the left-side points of the walking route, or a right-of-path region mask that connects upper-right and lower-right points of the pedestrian-perspective image and the right-side points of the walking route, or a combination thereof and may generate the mask image by intersecting the generated at least one region-specific mask with the pedestrian-perspective image.

Here, the program may estimate the speed of the pedestrian, and when generating the mask image, the program may additionally generate a far-distance mask that reflects the speed of the pedestrian and may generate at least one mask image by intersecting the generated at least one region-specific mask, the far-distance mask, and the pedestrian-perspective image.

Here, when obtaining the answer of the vision-language model, the program may input the query sentence and at least one region-specific mask image corresponding thereto to the vision-language model and generate a descriptive sentence for describing the pedestrian-perspective image by combining at least one answer obtained from the vision-language model.

Here, when providing the walking guidance, the program may remove keywords other than walking-related and risk-related keywords from at least one answer obtained from the vision-language model and construct a single sentence from remaining portion of the answer.

A method for walking route guidance based on a vision-language model according to an embodiment may include setting a walking route to a destination position in a pedestrian-perspective image, generating a query sentence by reflecting current condition information of a pedestrian to a query input by the pedestrian, extracting at least one mask image by extracting a predetermined region of interest from the pedestrian-perspective image in consideration of the speed of the pedestrian, obtaining an answer of a vision-language model by inputting the generated query sentence and the corresponding mask image, and providing walking guidance based on the answer of the vision-language model.

Here, providing the walking guidance may comprise removing keywords other than walking-related and risk-related keywords from at least one answer obtained from the vision-language model and constructing a single sentence from remaining portion of the answer.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of an apparatus for walking route guidance based on a vision-language model according to an embodiment;

FIG. 2 is an exemplary view of input/output of a route setting unit according to an embodiment;

FIGS. 3 and 4 are exemplary views of input/output of a mask generation unit according to an embodiment;

FIG. 5 is an exemplary view of input/output of a mask generation unit that reflects speed according to an embodiment;

FIGS. 6 and 7 are exemplary views for explaining a process of obtaining an answer by a VLM query unit according to an embodiment;

FIG. 8 is an exemplary view of input/output of a postprocessing unit according to an embodiment;

FIG. 9 is a flowchart for explaining a method for walking route guidance based on a vision-language model according to an embodiment; and

FIG. 10 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

With the recent development of Artificial Intelligence (AI) and computer vision technology and emergence of Vision Language Model (VLM), which combines image information and language information, technologies using these are attracting a lot of attention.

Accordingly, the present disclosure utilizes VLM technology to help a user safely reach a destination. That is, the present disclosure intends to improve pedestrian safety and convenience by providing real-time guidance on the route to a specific point through VLM by using images captured from the viewpoint of a pedestrian such that the user obtains detailed information about the surrounding environment and the route.

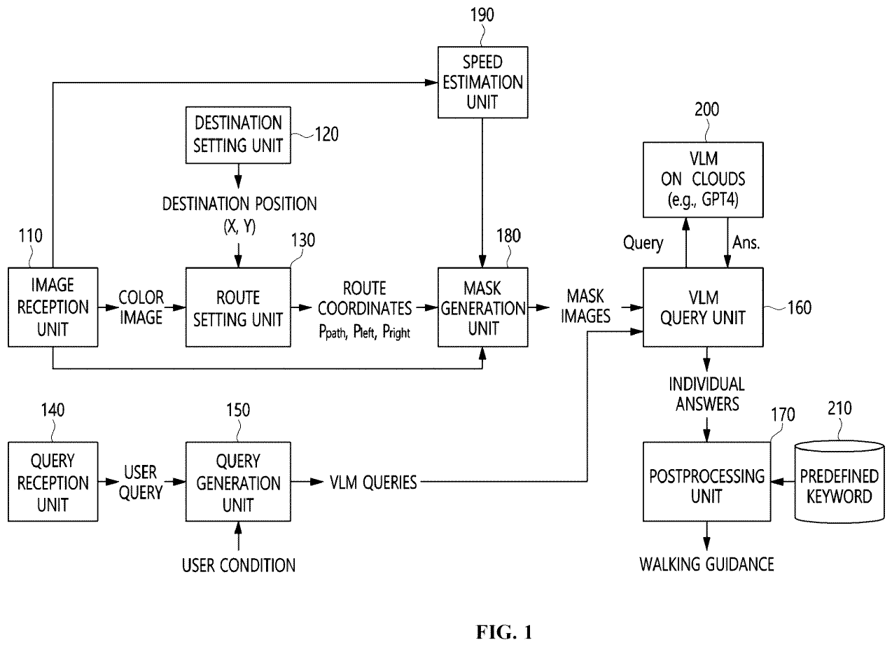

FIG. 1 is a schematic block diagram of an apparatus for walking route guidance based on a vision-language model according to an embodiment.

Referring to FIG. 1, the apparatus for walking route guidance based on a vision-language model according to an embodiment may include an image reception unit 110, a destination setting unit 120, a route setting unit 130, a query reception unit 140, a query generation unit 150, a VLM query unit 160, and a postprocessing unit 170.

Additionally, the apparatus for walking route guidance based on a vision-language model according to an embodiment may further include a mask generation unit 180, a speed estimation unit 190, a VLM 200, and a predefined keyword DB 210.

The image reception unit 110 receives an image captured from the viewpoint of a pedestrian. For example, the image may be received from an image-capturing device mounted on an actual pedestrian or a guide dog or an auxiliary device for assisting the pedestrian.

The destination setting unit 120 may set a destination position (x, y) within the pedestrian-perspective image.

Here, the destination position (x, y) may be obtained by analyzing a command of the pedestrian and utilizing object recognition technology, or may be input through a user interface or an external navigation module.

The route setting unit 130 sets a walking route to the destination position (x, y) in the pedestrian-perspective image.

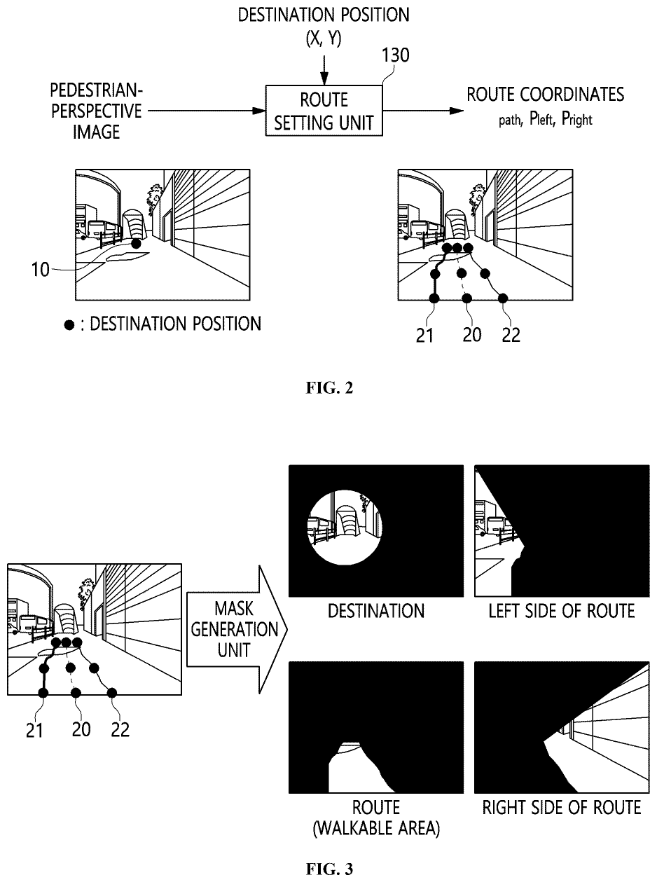

FIG. 2 is an exemplary view of input/output of a route setting unit according to an embodiment.

Referring to FIG. 2, the route setting unit 130 may receive the pedestrian-perspective image and the destination position 10 shown on the left side and output a pedestrian-perspective image in which route coordinates 20, 21 and 22 are displayed as shown on the right side.

Here, the route setting unit 130 may search for an optimal route that minimizes a movement route from the current position of the pedestrian to the destination position. That is, the route setting unit 130 may search for the optimal route using an optimization algorithm (e.g., an A* algorithm) to minimize the movement between the starting point (current position) and the destination such that the movement route of the pedestrian is minimized.

Also, the route setting unit 130 may use at least one of an algorithm for minimizing depth variation of the movement route based on a depth map, or a walkable area segmentation algorithm, or a combination thereof. That is, the depth variation of the movement route may be minimized using the depth map by setting the depth variation as the optimization target in addition to the movement route, or the optimization target may be adjusted to prioritize movement to a walkable area by utilizing the walkable area segmentation algorithm.

Here, the depth map may be obtained from a separate sensor, such as a LiDAR device, a stereo camera, or the like, or through a monocular depth estimation method.

Here, the route setting unit 130 may compute left points 21 and right points 22 at a predetermined distance from each of a predetermined number of points on the walking route 20.

That is, the route setting unit 130 may generate a total of N points by interpolating between the found points and compute the left-side and right-side points P_{i,left} and P_{i,right} 21 and 22 of the walkable area having a width w by using the N points P_{i,path}=(xᵢ, yᵢ) 20 and the depth value zi.

Here, the left-side and right-side points may be obtained through camera parameters or a pretrained deep-learning model.

Referring again to FIG. 1, the query reception unit 140 may receive a query command from a user through a user interface and convert the same into a text form.

The query generation unit 150 may generate a query sentence by reflecting the current condition information of the pedestrian to the query input by the pedestrian. Table 1 below is an example of input/output of the query generation unit 150.

TABLE 1
User query: Explain the route to the destination
-[extract keyword]−> destination, route explanation
-[add user conditions]−> destination, route explanation, landmark-based
explanation, ignore low obstacles
-[add region information]−> destination, route explanation,
landmark-based explanation, ignore low obstacles, left side of the route
-[reconstruct as a query sentence]−> Explain, focusing on landmarks, the
left side of the route to the destination while ignoring low obstacles

First, the query generation unit 150 may separate keywords from the basic query of a user. For example, referring to Table 1, keywords representing the request of the user, such as ‘destination’ and ‘route explanation’ may be extracted from a user query such as “Explain the route to the destination”.

Subsequently, the query generation unit 150 may add user conditions to the extracted keywords. That is, a query sentence that reflects user conditions, such as whether the user is accompanied by a guide dog, the walking proficiency, the familiarity with the route, and the like, may be generated to provide a personalized route explanation.

For example, if the user is accompanied by a guide dog, navigation targets based on landmarks may be explained first. However, if the user is walking alone without any assistive device, obstacles and navigation targets may be explained together.

Also, if the user is experienced, low obstacles may be ignored, but if the user is a beginner, low obstacles may also be explained. Also, if the route is familiar to the user, only a brief explanation may be provided, but if the route is unfamiliar, a detailed explanation may be provided.

That is, referring to Table 1, user conditions such as ‘landmark-based explanation’ and ‘ignore low obstacles’ may be added to the extracted keywords ‘destination’ and ‘route explanation’.

Meanwhile, the query generation unit 150 may add regional information to the query sentence. That is, referring to Table 1, regional information such as ‘the left side of the route’ may be added.

Accordingly, the final query sentence may be ‘Explain, focusing on landmarks, the left side of the route to the destination while ignoring low obstacles’.

Referring again to FIG. 1, the VLM query unit 160 inputs the generated query sentence and the pedestrian-perspective image and obtains an answer from the vision-language model 200 such as GPT.

The VLM query unit 160 may issue the query sentence along with a mask image corresponding thereto. Accordingly, only a related region is provided using the mask image, whereby accuracy of the explanation may be improved.

To this end, the mask generation unit 180 may generate a mask by extracting a predetermined region of interest using the route coordinates in the pedestrian-perspective image.

Here, the mask may represent the region of interest as ‘1’ and all other regions as ‘0’.

Here, the mask generation unit 180 may generate at least one of a destination region mask, a path region mask, a right-of-path region mask, or a left-of-path region mask, or a combination thereof.

Here, the destination region mask is obtained by masking the destination region image in the form of a circle with a radius r, an ellipse, or a polygon using the destination position coordinates (x, y).

Also, the path region mask Mₚₐₜₕ may be generated by connecting the left-side and right-side points of the walking route in the pedestrian-perspective image.

Also, the left-of-path region mask M_{left} may be generated by connecting the upper-left point of the pedestrian-perspective image, the lower-left point thereof, and the left-side points P_{i,left} of the walking route.

The right-of-path region mask M_{right} may be generated by connecting the upper-right point of the pedestrian-perspective image, the lower-right point thereof, and the right-side points P_{i,right} on the walking route.

Subsequently, the mask generation unit 180 may generate a region-specific mask image by intersecting the generated at least one region-specific mask with the pedestrian-perspective image.

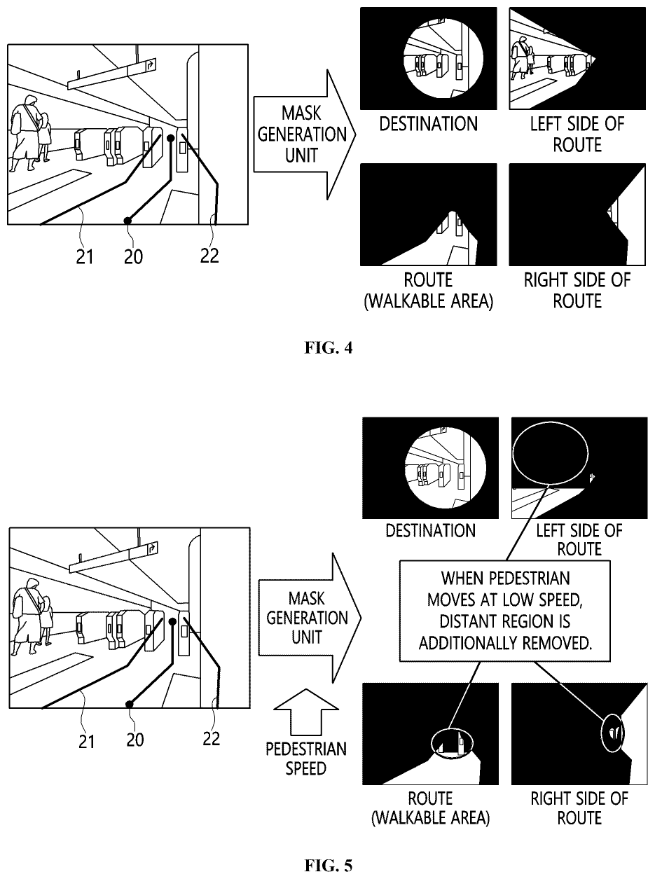

FIGS. 3 and 4 are exemplary views of input/output of a mask generation unit according to an embodiment.

Referring to FIG. 3, when it receives a walking route Pₚₐₜₕ leading to the subway entrance and the left and right coordinates P_{left} and P_{right} of the route, the mask generation unit 180 may extract a destination mask image that shows the subway entrance corresponding to the destination in a circular form and mask images that show the left region of the route, the walkable route region, and the right region of the route.

Referring to FIG. 4, the destination is located beyond the ticket gate of the subway, and it is impossible to move directly toward the destination in a straight line. The route setting unit 130 computes a route Pₚₐₜₕ 20 for safely passing through the ticket gate while avoiding obstacles and the left and right coordinates P_{left} and P_{right} 21 and 22, and the mask generation unit 180 generates mask images for the destination, the route, and the left and right sides of the route.

Meanwhile, the mask generation unit 180 may generate a mask by adjusting a predetermined region of interest based on the pedestrian speed estimated by the speed estimation unit 190. That is, the walking speed of the user is estimated, and the mask is dynamically adjusted, whereby personalized guidance may be provided according to the movement conditions of the user.

Here, the speed estimation unit 190 may obtain speed information by computing an optical flow from consecutive camera images or by using an external sensor (an accelerometer, a gyroscope, or GPS data).

The mask generation unit 180 may adjust the mask as shown in Equation (1) below:

$${M}_{far} = {M}_{near} + a * v \qquad ( 1 )$$

In Equation (1), v denotes the pedestrian speed, and when v is low, the mask may be adjusted to focus on a nearby object and path, whereas when v is high, the mask may be adjusted to focus on a more distant object and path.

That is, the mask generation unit 180 intersects a far-distance mask M_{far}, which reflects the speed and each of the region-specific masks Mₚₐₜₕ, M_{left}, and M_{right}, with the pedestrian-perspective image I, thereby obtaining the region-specific mask images Iₚₐₜₕ, I_{left}, and I_{right}.

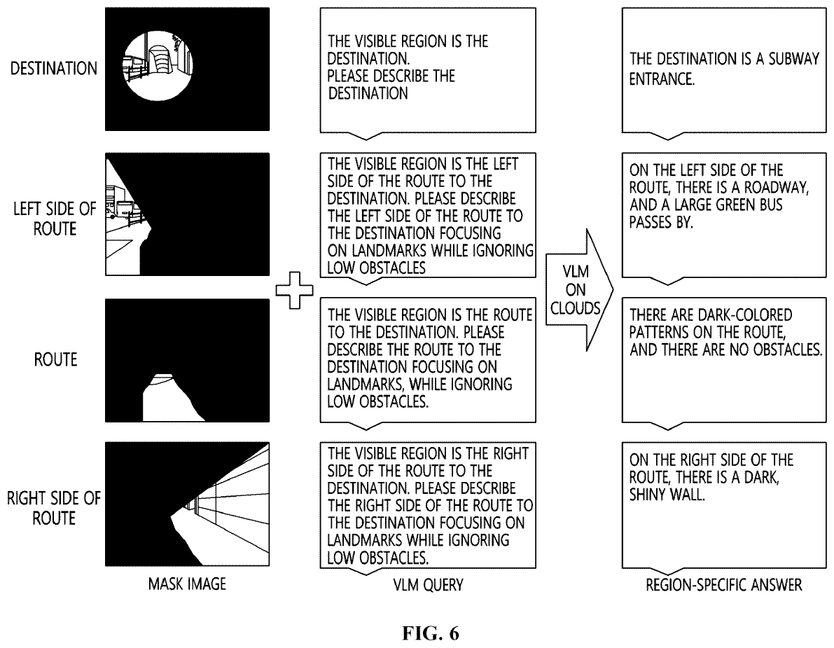

FIG. 5 is an exemplary view of input/output of a mask generation unit that reflects speed according to an embodiment.

Referring to FIG. 5, in addition to the route Pₚₐₜₕ 20 leading to the destination (the area beyond the subway ticket gate) and the left and right coordinates P_{left} and P_{right} of the route (21 and 22), the pedestrian speed is given. Here, when the pedestrian moves at a low speed, the mask generation unit 180 may generate mask images that show only nearby regions by masking out distant regions in consideration of the speed.

Accordingly, the VLM query unit 160 inputs a query sentence and at least one region-specific mask image corresponding thereto to the vision-language model 200 and combines at least one answer obtained from the vision-language model 200, thereby generating a descriptive sentence for describing the pedestrian-perspective image.

Also, the VLM query unit 160 may input the descriptive sentence for describing the pedestrian-perspective image after adding a query sentence about walkability thereto and may obtain an answer indicating walkability along the walking route from the vision-language model 200.

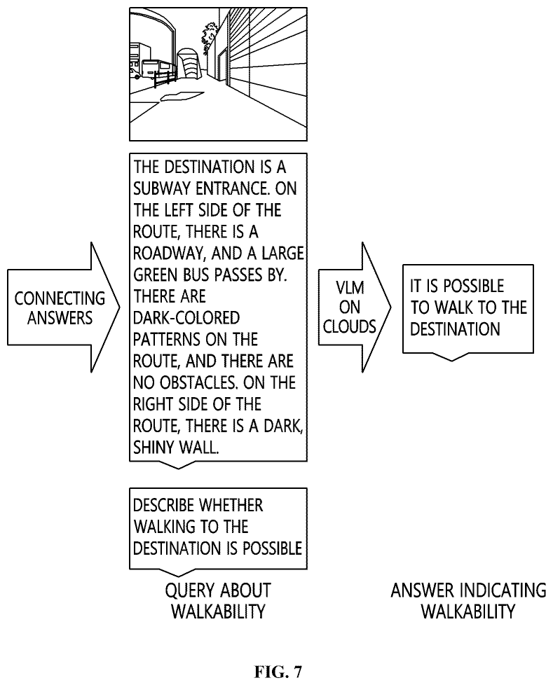

FIGS. 6 and 7 are exemplary views for explaining a process of obtaining answers by a VLM query unit according to an embodiment.

After region-specific answers are obtained through VLM queries corresponding to region-specific mask images, as illustrated in FIG. 6, a descriptive sentence for describing a pedestrian-perspective image is generated by combining the region-specific answers, as illustrated in FIG. 7. Then, an answer indicating walkability along the route may be obtained through an additional VLM query about walkability.

Also, the VLM query unit 160 may selectively use only some mask images when the query of a user pertains to a specific region, not to a general description of the route. For example, when the user asks, “explain the destination”, only the mask image for the destination and the VLM query are sent to the VLM on clouds, whereby an answer is obtained.

Also, when the user moves along a frequently used route and already knows about the right side of the route, there is no need to explain the right side of the route, so the VLM query unit 160 may construct region-specific answers by querying the VLM on clouds 200 with only the destination, the route, and the left side of the route, excluding the right side of the route.

As described above, depending on the user query and the situation, the mask images and the VLM queries may be selectively used for queries to be sent to the VLM on clouds 200.

Referring again to FIG. 1, the postprocessing unit 170 provides walking guidance based on the answer of the vision-language model 200.

Here, the postprocessing unit 170 may remove all keywords excluding risk-related keywords and keywords identified by referring to the predefined keyword DB 210 from at least one answer obtained from the vision-language model 200 and construct a single sentence from the remaining portion of the answer.

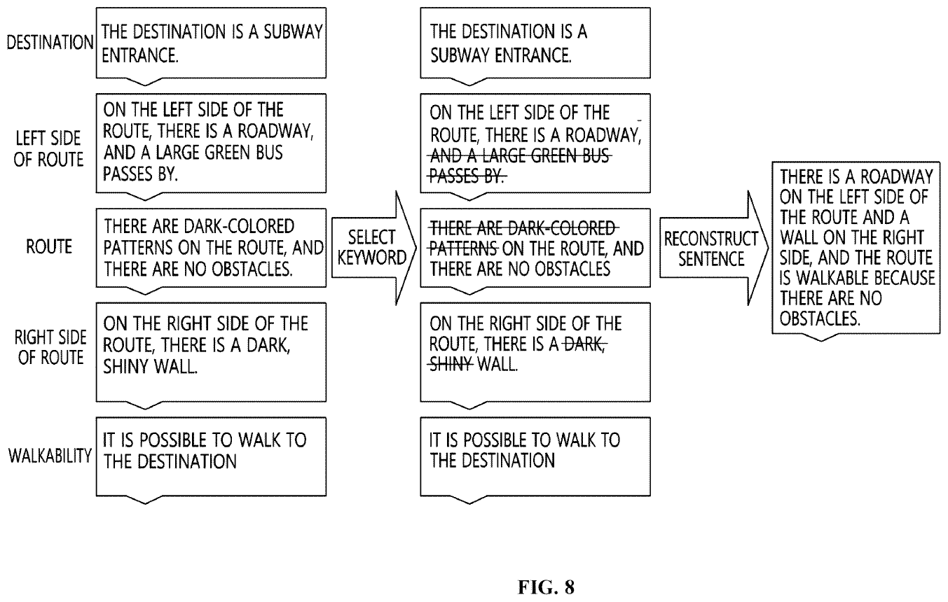

FIG. 8 is an exemplary view of input/output of a postprocessing unit according to an embodiment.

Referring to FIG. 8, the postprocessing unit 170 may generate a single sentence by aggregating answers obtained from the vision-language model 200 and perform final review before providing the same to a user. That is, only predefined walking-related keywords and risk-related keywords remain in each sentence, and unrelated keywords are removed therefrom, after which a single sentence is generated from the remaining portion of the sentence.

Accordingly, unnecessary information is removed, and important information is clearly and concisely conveyed, whereby it is possible to support safe and efficient walking and contribute to the advancement of pedestrian assistance technology.

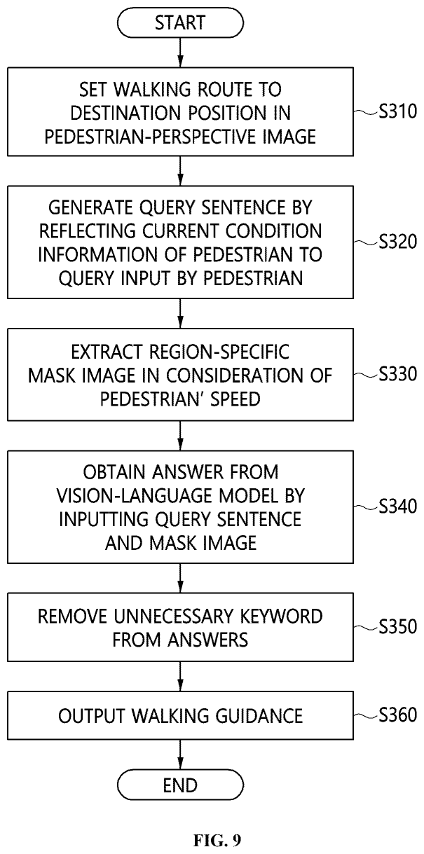

FIG. 9 is a flowchart for explaining a method for walking route guidance based on a vision-language model according to an embodiment.

Referring to FIG. 9, the method for walking route guidance based on a vision-language model according to an embodiment may include setting a walking route to a destination position in a pedestrian-perspective image at step S310, generating a query sentence by reflecting current condition information of a pedestrian to a query input by the pedestrian at step S320, obtaining an answer of a vision-language model by inputting the generated query sentence and the pedestrian-perspective image at step S340, and providing walking guidance based on the answer of the vision-language model at step S360.

Here, setting the walking route at step 310 may include detailed steps corresponding to the above-described operations of the image reception unit 110, the destination setting unit 120, and the route setting unit 130.

The method for walking route guidance based on a vision-language model according to an embodiment may further include generating a mask image by extracting a predetermined region of interest from the pedestrian-perspective image at step S330, and obtaining the answer of the vision-language model at step S340 may comprise inputting a mask image corresponding to the generated query sentence to the vision-language model.

Here, generating the mask image at step S330 may include detailed steps corresponding to the above-described operation of the mask generation unit 180.

Here, the method for walking route guidance based on a vision-language model according to an embodiment further includes estimating the speed of the pedestrian, and generating the mask image at step S330 may comprise generating a mask by adjusting a predetermined region of interest based on the speed of the pedestrian.

Here, generating the mask image at step S330 may comprise generating at least one of a destination region mask from the pedestrian-perspective image, a path region mask that connects the left-side and right-side points of the walking route in the pedestrian-perspective image, a left-of-path region mask that connects the upper-left and lower-left points of the pedestrian-perspective image and the left-side points of the walking route, or a right-of-path region mask that connects the upper-right and lower-right points of the pedestrian-perspective image and the right-side points of the walking route, or a combination thereof and generating a mask image by intersecting the generated at least one mask image with the pedestrian-perspective image.

Here, obtaining the answer of the vision-language model at step S340 may include detailed steps corresponding to the above-described operation of the VLM query unit 160.

Here, providing the walking guiding at steps S350 to S360 may comprise removing keywords other than walking-related and risk-related keywords from at least one answer obtained from the vision-language model at step S350 and constructing a single sentence from the remaining portion of the answer. Here, providing the walking guidance at steps S350 to S360 may include detailed steps corresponding to the above-described operation of the postprocessing unit 170.

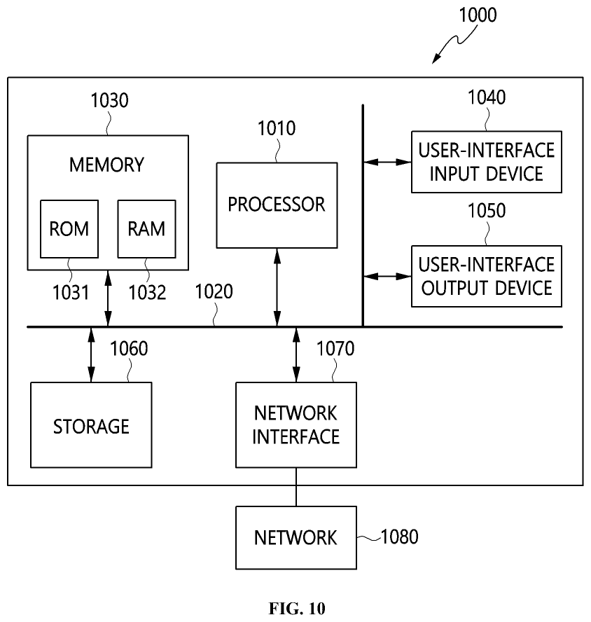

FIG. 10 is a view illustrating a computer system configuration according to an embodiment.

The apparatus for walking route guidance based on a vision-language model according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

Also, although not illustrated in the drawing, the apparatus for walking route guidance based on a vision-language model may further include a camera for capturing an image from the viewpoint of a pedestrian and a speed estimation sensor for estimating the walking speed of the user.

According to the disclosed embodiment, changes in the pedestrian's surrounding environment and obstacles may be detected in real time and delivered to the user.

According to the disclosed embodiment, user experience may be improved by taking into account the user's walking speed and individual characteristics, and safety issues may be addressed.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for walking route guidance based on a vision-language model, comprising:
setting a walking route to a destination position in a pedestrian-perspective image;
generating a query sentence by reflecting current condition information of a pedestrian to a query input by the pedestrian;
obtaining an answer of a vision-language model by inputting the generated query sentence and the pedestrian-perspective image; and
providing walking guidance based on the answer of the vision-language model.

2. The method of claim 1, wherein setting the walking route comprises
searching for an optimal route for minimizing a movement route from a current position of the pedestrian to the destination position, and
using at least one of an algorithm for minimizing depth variation of the movement route based on a depth map, or a walkable area segmentation algorithm, or a combination thereof.

3. The method of claim 2, wherein setting the walking route comprises computing left and right points at a predetermined distance from each of a predetermined number of points on the walking route.

4. The method of claim 3, further comprising:
generating a mask image by extracting only a predetermined region of interest from the pedestrian-perspective image,
wherein obtaining the answer of the vision-language model comprises inputting a mask image corresponding to the generated query sentence to the vision-language model.

5. The method of claim 4, wherein generating the mask image comprises
generating at least one of a destination region mask from the pedestrian-perspective image, a path region mask that connects left-side and right-side points of a walking route in the pedestrian-perspective image, a left-of-path region mask that connects upper-left and lower-left points of the pedestrian-perspective image and the left-side points of the walking route, or a right-of-path region mask that connects upper-right and lower-right points of the pedestrian-perspective image and the right-side points of the walking route, or a combination thereof; and
generating a mask image by intersecting the generated at least one region-specific mask with the pedestrian-perspective image.

6. The method of claim 5, further comprising:
estimating a speed of the pedestrian,
wherein generating the mask image comprises additionally generating a far-distance mask that reflects the speed of the pedestrian and generating at least one mask image by intersecting the generated at least one region-specific mask, the far-distance mask, and the pedestrian-perspective image.

7. The method of claim 6, wherein obtaining the answer of the vision-language model comprises
inputting the query sentence and at least one region-specific mask image corresponding to the query sentence to the vision-language model; and
generating a descriptive sentence for describing the pedestrian-perspective image by combining at least one answer obtained from the vision-language model.

8. The method of claim 7, wherein obtaining the answer of the vision-language model further comprises
inputting the descriptive sentence to the vision-language model after adding a query sentence about walkability to the descriptive sentence for describing the pedestrian-perspective image; and
obtaining an answer indicating walkability along the walking route from the vision-language model.

9. The method of claim 1, wherein providing the walking guidance comprises
removing keywords other than walking-related and risk-related keywords from at least one answer obtained from the vision-language model and constructing a single sentence from remaining portion of the answer.

10. An apparatus for walking route guidance based on a vision-language model, comprising:
memory in which at least one program is recorded; and
a processor for executing the program,
wherein the program sets a walking route to a destination position in a pedestrian-perspective image, generates a query sentence by reflecting current condition information of a pedestrian to a query input by the pedestrian, obtains an answer of a vision-language model by inputting the generated query sentence and the pedestrian-perspective image, and provides walking guidance based on the answer of the vision-language model.

11. The apparatus of claim 10, wherein, when setting the walking route, the program searches for an optimal route for minimizing a movement route from a current position of the pedestrian to the destination position and uses at least one of an algorithm for minimizing depth variation of the movement route based on a depth map, or a walkable area segmentation algorithm, or a combination thereof.

12. The apparatus of claim 11, wherein, when setting the walking route, the program computes left and right points at a predetermined distance from each of a predetermined number of points on the walking route.

13. The apparatus of claim 12, wherein the program generates a mask image by extracting a predetermined region of interest from the pedestrian-perspective image, and when obtaining the answer of the vision-language model, the program inputs a mask image corresponding to the generated query sentence to the vision-language model.

14. The apparatus of claim 13, wherein, when generating the mask image, the program generates at least one of a destination region mask from the pedestrian-perspective image, a path region mask that connects left-side and right-side points of the walking route in the pedestrian-perspective image, a left-of-path region mask that connects upper-left and lower-left points of the pedestrian-perspective image and the left-side points of the walking route, or a right-of-path region mask that connects upper-right and lower-right points of the pedestrian-perspective image and the right-side points of the walking route, or a combination thereof; and generates the mask image by intersecting the generated at least one region-specific mask with the pedestrian-perspective image.

15. The apparatus of claim 14, wherein the program estimates a speed of the pedestrian, and when generating the mask image, the program additionally generates a far-distance mask reflecting the speed of the pedestrian and generates at least one mask image by intersecting the generated at least one region-specific mask, the far-distance mask, and the pedestrian-perspective image.

16. The apparatus of claim 15, wherein, when obtaining the answer of the vision-language model, the program inputs the query sentence and at least one region-specific mask image corresponding thereto to the vision-language model and generates a descriptive sentence for describing the pedestrian-perspective image by combining at least one answer obtained from the vision-language model.

17. The apparatus of claim 16, wherein, when obtaining the answer of the vision-language model, the program adds a query sentence about walkability to the descriptive sentence for describing the pedestrian-perspective image, inputs the descriptive sentence to the vision-language model, and obtains an answer indicating walkability along the walking route from the vision-language model.

18. The apparatus of claim 10, wherein, when providing the walking guidance, the program removes keywords other than walking-related and risk-related keywords from at least one answer obtained from the vision-language model and constructs a single sentence from remaining portion of the answer.

19. A method for walking route guidance based on a vision-language model, comprising:
setting a walking route to a destination position in a pedestrian-perspective image;
generating a query sentence by reflecting current condition information of a pedestrian to a query input by the pedestrian;
extracting at least one mask image by extracting a predetermined region of interest from the pedestrian-perspective image in consideration of a speed of the pedestrian;
obtaining an answer of a vision-language model by inputting the generated query sentence and a mask image corresponding thereto; and
providing walking guidance based on the answer of the vision-language model.

20. The method of claim 19, wherein providing the walking guidance comprises removing keywords other than walking-related and risk-related keywords from at least one answer obtained from the vision-language model and constructing a single sentence from remaining portion of the answer.
